(19) United States
(12) Patent Application Publication
(10) Pub. No.: US 2007/0299747 A1
(43) Pub. Date: Dec. 27, 2007

(54) Method and system for replenishing rotable inventory

(75) Inventors: Bret Allen Shorter, Morton, IL (US); Cassandra Lea Osborne, East Peoria, IL (US); Amy Michelle Ahlers, Morton, IL (US); Jennifer Katherine Aspinall, East Peoria, IL (US); Andrew James Graves, Tremont, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/607,238

(22) Filed: Nov. 30, 2006

Related U.S. Application Data
(60) Provisional application No. 60/816,313, filed on Jun. 26, 2006.

(51) Int. Cl. G06Q 10/00

(52) U.S. Cl. 705/28; 700/106

(57) ABSTRACT

A method for replenishing rotable material associated with a parts exchange program comprises receiving replenishment data associated with a part number, and estimating projected rotable requirements for the part number based on the replenishment data. A supplemental quantity of new materials required to meet the projected rotable requirements is determined if the projected rotable requirements exceed an available rotable or core quantity. Future new material requirements for the part number are estimated based on the replenishment data and the supplemental quantity of new materials required to meet the projected rotable requirements. A purchase order for new material is generated based on the future new material requirements if the amount of new material onhand is not sufficient to support new demand and needed rotable supplement material.

This application claims priority to and the benefit of the filing date of U.S. Provisional Patent Application No. 60/816,313, filed Jun. 26, 2006, which is herein incorporated by reference in its entirety.

### TECHNICAL FIELD

The present disclosure relates generally to inventory management processes for supply chain environments and, more particularly, to methods and systems for replenishing rotable inventory levels in a supply chain environment.

### BACKGROUND

Inventory tracking and management systems are invaluable tools for optimizing stock levels for parts dealers, distribution facilities, and distribution networks. If stock levels are too low, a dealer could lose sales as potential customers take their business elsewhere. The loss of business could be even greater if the customer decides to take all of their future business elsewhere. If stock levels are too high, the dealer could incur extra costs associated with maintaining excess stock (e.g., higher costs for larger storage space, higher insurance costs, etc.).

An accurate forecast of the demand for parts may facilitate a determination of optimum stock levels. It is further helpful to obtain demand forecast data separately indicating data for various categories or types of part, as there may be several versions of a particular part. For example, the same part may be available in both a new version and a used version that has been refurbished in some way (e.g., repaired, remanufactured, overhauled, etc.). Such used but refurbished parts are known as rotable parts and are often sold on an exchange basis. When parts are sold on an exchange basis through an exchange program, customers who have a part that is at or near the end of its useful life may, when purchasing a replacement part, turn in (exchange) the part that they wish to replace. The seller may then refurbish the part that was turned in and resell it as part of a future exchange transaction.

While there are many systems for tracking inventory of and/or forecasting demand for new parts, these systems do not forecast demand for rotable parts (e.g., no prediction is made for future demand for parts sold on an exchange basis). Systems have been developed that attempt to optimize stock levels for rotable parts. For example, U.S. Patent Application Publication No. 2005/0177467 by Wang et al. (“the '467 document”) discloses a rotable inventory calculation method. The '467 document teaches determining optimum stock levels for parts based on the likelihood that parts that have been turned in by customers for repair can be repaired within the timeframe requested (or contracted) by the customer. The '467 document suggests that the more frequently repairs are not able to be made within the desired time period, the more parts (of any type, e.g., rotable or new) should be kept in stock to be provided to customers in the event that the repair of their part is not completed within the desired time period.

Although the method described in the '467 document may attempt to estimate optimum rotable inventory stock levels based on a desired customer lead time, it may be inefficient and unreliable. For instance, while the method of the '467 document may determine an amount of rotable inventory to keep in stock to meet rotable part repair requests based on repair lead time, it fails to address demand fluctuations associated with new rotable parts requests. As a result, should new customers request rotable parts, the method of the '467 document may not stock the inventory necessary to meet the demand associated with the rotable part requests from new customers and the rotable part repair requests from existing customers.

The method of the '467 document does not provide a feature for determining deficiencies in rotable core material associated with an exchange pool or a means for supplementing core materials using an existing new material acquisition process. As a result, rotable exchange programs that experience fluctuations in the availability of viable core materials for rotable part manufacture may become inefficient without a method to integrate rotable replenishment processes within conventional supply chain replenishment processes.

The presently disclosed method and system for replenishing rotable inventory is directed toward overcoming one or more of the problems set forth above.

### SUMMARY OF THE INVENTION

In accordance with one aspect, the present disclosure is directed toward a method for replenishing rotable material associated with a parts exchange program. The method may comprise receiving replenishment data associated with a part number, and estimating projected rotable requirements for the part number based on the replenishment data. A supplemental quantity of new materials required to meet the projected rotable requirements may be determined if the projected rotable requirements exceed an available rotable or core quantity. Future new material requirements for the part number may be estimated based on the replenishment data and the supplemental quantity of new materials required to meet the projected rotable requirements. A purchase order for new material may be generated based on the future new material requirements.

According to another aspect, the present disclosure is directed toward an inventory replenishment method for rotable parts comprising a rotable material replenishment process and a new material replenishment process. The rotable material replenishment process may comprise receiving replenishment data associated with a part number. The rotable replenishment process may also include estimating projected rotable requirements for the part number based on the replenishment data. The rotable replenishment process may further include determining a supplemental quantity of new materials required to meet the projected rotable requirements if the projected rotable requirements exceed available core and rotable quantities. The new material replenishment process may comprise receiving new material replenishment data associated with a part number. The new material replenishment process may also include receiving data indicative of a quantity of cores required to meet the projected rotable requirements. Future new material requirements for the part number may be estimated based on the replenishment data and the supplemental quantity of new materials required to meet the projected rotable requirements. The new material replenishment process may also include generating a purchase order for new material based on the future new material requirements.

### BRIEF DESCRIPTION OF THE DRAWINGS

FIG. 1 illustrates an exemplary supply chain management environment in which processes and methods consistent with the disclosed embodiments may be implemented;

FIG. 2 provides a schematic illustration of an exemplary inventory management system in accordance with certain disclosed embodiments;

FIG. 3 is a timeline indicating lead time for repair of rotable parts according to an exemplary disclosed embodiment; and

FIG. 4 provides a flowchart depicting an exemplary method for replenishing rotable material quantities associated with a parts exchange program.

### DETAILED DESCRIPTION

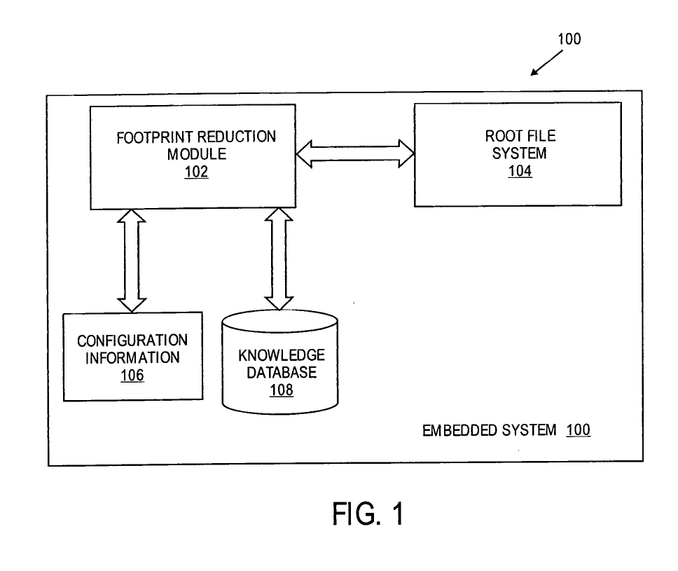

FIG. 1 illustrates an exemplary supply chain management environment 100 in which methods and processes consistent with the disclosed embodiments may be implemented. Supply chain management, as the term is used herein, refers to any process or system involved in the production, shipment, distribution, sale, tracking, or storage of goods between or among raw material suppliers, distributors, manufacturers, retailers, and customers. Furthermore, supply chain management may include quality control processes, logistics management processes, inventory management processes, and/or account management processes associated with the flow of data and materials within a particular supply chain. According to one embodiment, and as illustrated in FIG. 1, supply chain management environment 100 may include systems associated with one or more satellite facilities 110, one or more manufacturing (and/or remanufacturing) facilities 120, one or more master warehouses 130, and an inventory management system 140. These systems may be communicatively coupled to one or more other systems associated with supply chain management environment 100 via communication network 150. It is contemplated that, although the present disclosure may describe certain processes and functions as being performed by one or more facilities or warehouses described above, these processes and functions may be performed manually (e.g., by personnel associated with the respective facility) and/or electronically, by one or more computer systems associated with a respective facility.

Satellite facility 110 may include a computer system for receiving, analyzing, tracking, updating, and/or processing customer part requests. For example, satellite facility 110 may be associated with a retail or wholesale parts facility responsible for receiving and filling customer part orders; monitoring and maintaining local inventory levels; collecting and managing part returns, including new part returns, core returns, used part returns, etc.; filling part exchange requests; and/or receiving part shipments from one or more other facilities (e.g., manufacturing/remanufacturing facilities, distribution centers, regional warehouse storage facilities, and/or other part supplier facilities). According to one embodiment, a computer system associated with satellite facility 110 may monitor, record, and analyze data associated with each type of transaction (sales, returns, exchanges, core deposits, repairs, re-certifications, etc.) of the part supplier facility. This data may be periodically or continuously uploaded into a central backend system, such as inventory management system 140.

For purposes of the present disclosure, core material may include any type of new or used “base” material that can be remanufactured or reused in the production of a rotable part. In some situations, core material may include certain components of a part that have a useful life beyond the useful life of the part. For example, a permanent magnet rotor in an electric motor may be reused in the remanufacture of several electric motors, as the permanent magnet portion of the rotor typically undergoes very little wear. Cost savings may be realized for both the manufacturer and the customer, as the permanent magnet of a motor often represents a large percentage of the overall cost of the motor. Alternatively and/or additionally, core material can include rotable exchange material (e.g., a spent part) returned by a customer as part of an exchange program. This rotable exchange material may be inspected to determine which, if any, core components can be reused. Upon inspection, the rotable exchange material may be disassembled to retrieve any viable core material.

Manufacturing facility 120 and remanufacturing facility 122 may each include a computer system for monitoring, analyzing, and/or recording data associated with the manufacturing of new parts or the repair, recertification, or remanufacturing of used parts. For example, manufacturing facility 120 may be associated with a part manufacturing plant involved in the assembly and manufacturing of new parts for eventual consumption by an end user. Remanufacturing facility 122 may be associated with a part repair/remanufacturing plant involved in the repair, remanufacture, assembly, and recertification of used parts to return the used part back into saleable material. According to one embodiment, a computer system associated with each of manufacturing facility 120 and remanufacturing facility 122 may embody a computer system configured to monitor, analyze, record, and/or control one or more aspects associated with the operation of the manufacturing plant.

As illustrated in FIG. 1, manufacturing facility 120 may be configured to manage inventory associated with the manufacturing plant. For example, manufacturing facility 120 may be configured to monitor and track the receipt of parts returned by one or more customers, monitor the shipment of rotable and/or new parts to one or more distribution centers, monitor and adjust the production level associated with the manufacture of new parts and/or the remanufacture, repair, or recertification of used. Manufacturing facility 120 may be configured to continuously or periodically provide manufacturing facility data to inventory management system 140.

Master warehouses 130 may include a computer system for monitoring and managing inventory associated with one or more distribution centers. For example, master warehouses 130 may be adapted to monitor and track the receipt of parts (e.g., new parts, rotable parts, etc.) from a manufacturing plant, as well as the shipment and distribution of parts from the distribution center. Rotable parts, as the term is used herein, refers to any part that is manufactured in such a way that the part (or a component thereof) may be repaired, remanufactured, or overhauled so as to reset at least a portion of the usable life thereof.

Inventory management system 140 may include an electronic system configured to monitor and record inventory data associated with supply chain environment 100. For example, the inventory management system 140 may be communicatively coupled to one or more of satellite facility 110, manufacturing system 120, and distribution system 130. Inventory management system 140 may collect inventory data associated with each respective system, monitor and control the flow of inventory between or among each system, and adapt supply chain resources to ensure the appropriate operation of supply chain environment 100.

According to one embodiment, inventory management system 140 may receive data associated with a satellite facility from a corresponding satellite facility 110 and store the data in memory for future analysis. For example, inventory management system 140 may receive customer orders from a satellite facility. Customer orders may include, among other things, information identifying a requested part, a desired quantity associated with a requested part, a desired part condition associated with a requested part (e.g., new, re-certified, repaired, remanufactured, etc.) and information that may correspond to a return transaction associated with the customer order (e.g., whether the order includes an accompanying core return, rental return, repair and/or overhaul part return). This information may be stored in an inventory management database associated within the inventory management system 140 for future analysis.

The inventory management system 140 may be adapted to monitor, analyze, and record data received from manufacturing facility 120 (via a computer system associated therewith) and provide commands to manufacturing facility 120 for adjusting productivity levels of the manufacturing plant to meet customer demand. It is contemplated that inventory management system 140 may adjust the levels associated with both new and rotable parts. For instance, inventory management system 140 may reduce the level of production for new parts associated with a particular part number based on a decrease in demand for new parts. Alternatively and/or additionally, inventory management system 140 may increase the amount of cores being repaired, based on an increase in customer demand for remanufactured parts.

Inventory management system 140 may be configured to account for part supersession. For example, in the event that a product has been replaced by a different part (e.g., superseded) or happens to be interchangeable with a different part, inventory management system 140 may be configured to roll demand to the different part before executing the forecast. This will ensure that the latest part that the vendor supports will be the part for which the demand is forecasted and replenished.

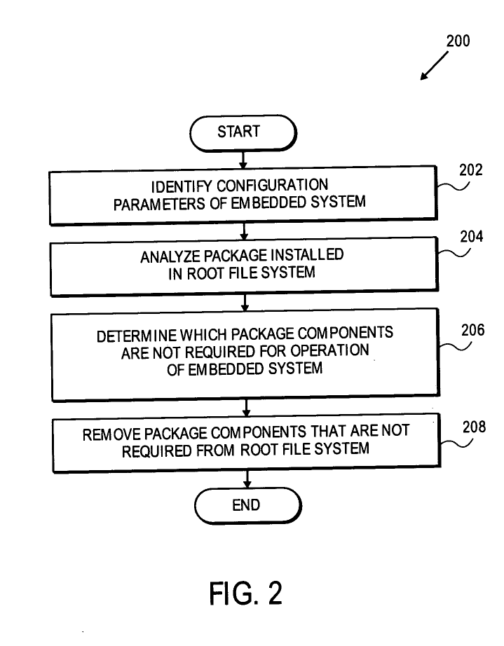

Inventory management system 140 may include any type of processor-based system on which processes and methods consistent with the disclosed embodiments may be implemented. For example, as illustrated in FIG. 2, inventory management system 140 may include one or more hardware and/or software components configured to execute software programs, such as software for managing supply chain environment 100, inventory monitoring software, or inventory transaction software. For example, inventory management system 140 may include one or more hardware components such as, a central processing unit (CPU) 141, a random access memory (RAM) module 142, a read-only memory (ROM) module 143, a storage system 144, a database 145, one or more input/output (I/O) devices 146, and an interface 147. Alternatively and/or additionally, inventory management system 140 may include one or more software components such as, for example, a computer-readable medium including computer-executable instructions for performing methods consistent with certain disclosed embodiments. It is contemplated that one or more of the hardware components listed above may be implemented using software. For example, storage 144 may include a software partition associated with one or more other hardware components of inventory management system 140. Inventory management system 140 may include additional, fewer, and/or different components than those listed above. It is understood that the components listed above are exemplary only and not intended to be limiting.

CPU 141 may include one or more processors, each configured to execute instructions and process data to perform one or more functions associated with inventory management system 140. As illustrated in FIG. 2, CPU 141 may be communicatively coupled to RAM 142, ROM 143, storage 144, database 145, I/O devices 146, and interface 147. CPU 141 may be configured to execute sequences of computer program instructions to perform various processes, which will be described in detail below. The computer program instructions may be loaded into RAM for execution by CPU 141.

RAM 142 and ROM 143 may each include one or more devices for storing information associated with an operation of inventory management system 140 and/or CPU 141. For example, ROM 143 may include a memory device configured to access and store information associated with inventory management system 140, including information for identifying, initializing, and monitoring the operation of one or more components and subsystems of inventory management system 140. RAM 142 may include a memory device for storing data associated with one or more operations of CPU 141. For example, ROM 143 may load instructions into RAM 142 for execution by CPU 141.

Storage 144 may include any type of mass storage device configured to store information that CPU 141 may need to perform processes consistent with the disclosed embodiments. For example, storage 144 may include one or more magnetic and/or optical disk devices, such as hard drives, CD-ROMs, DVD-ROMs, or any other type of mass media device.

Database 145 may include one or more software and/or hardware components that cooperate to store, organize, sort, filter, and/or arrange data used by inventory management system 140 and/or CPU 141. For example, database 145 may include historical data such, for example, historic inventory fluctuations and/or past customer order data. CPU 141 may also analyze current and previous inventory demand records to identify trends in inventory count adjustment. These trends may then be recorded and analyzed to adjust one or more aspects associated with an inventory control process, which may potentially reduce inventory management errors, washout, and/or product over- or under-stocking. It is contemplated that database 145 may store additional and/or different information than that listed above.

I/O devices 146 may include one or more components configured to communicate information with a user associated with inventory management system 140. For example, I/O devices may include a console with an integrated keyboard and mouse to allow a user to input parameters associated with inventory management system 140. I/O devices 146 may also include a display including a graphical user interface (GUI) for outputting information on a monitor. I/O devices 146 may also include peripheral devices such as, for example, a printer for printing information associated with inventory management system 140, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 147 may include one or more components configured to transmit and receive data via a communication network, such as the Internet, a local area network, a workstation peer-to-peer network, a direct link network, a wireless network, or any other suitable communication platform. For example, interface 147 may include one or more modulators, demodulators, multiplexers, demultiplexers, network communication devices, wireless devices, antennas, modems, and any other type of device configured to enable data communication via a communication network.

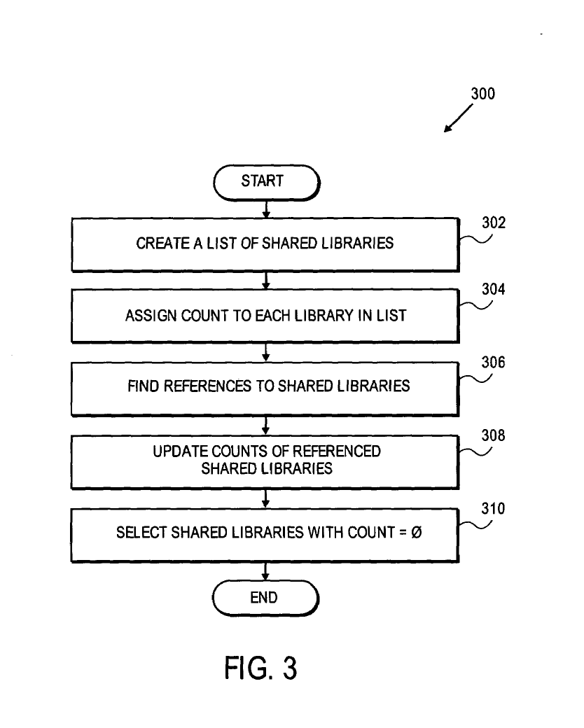

According to one embodiment, this replenishment process may depend on a remanufacturing lead time for the requested part. The remanufacturing lead time may include the time periods for various steps in the remanufacturing process, namely, how long it takes to repair a rotable part. FIG. 3 is a time line illustrating various steps in an exemplary remanufacturing process. The time periods illustrated and discussed with regard to FIG. 3 are intended to be exemplary only. Such time periods may vary from one application to another. The time periods illustrated in FIG. 3 are not intended to be proportional to the amounts of time that they respectively represent.

As illustrated in FIG. 3, a first time period 44 indicates the amount of time a core material or part (i.e., a part that is in need of repair) remains at a distribution center (e.g., in seller's possession). At some point in time 46, the core may be shipped to a remanufacturer for repair. Time period 48 indicates the amount of time that the core may be in transit from the distribution center to the repair site (i.e., the remanufacturer). Time period 50 indicates the amount of time that the core material remains in the possession of the remanufacturer until it is repaired. Time period 52 indicates the transit time from the repair site back to the distribution center. When the repaired part arrives back at the distribution center, it may spend some time in a quality control process. Once the quality control process is completed, the part may, at point in time 56, be ready and available for resale to requesting customers. In an exemplary embodiment, the total time between point in time 46 and point in time 56 may be the remanufacturing lead time used for demand forecasting and replenishment. Once the repaired part is available for sale, time period 57 indicates the amount of time the part sits on a shelf (or otherwise remains in stock) until a customer makes a request for it at point in time 58.

In some cases, the requested part may be available for off-the-shelf purchase at point in time 58. However, other parts may require a period of time 60 for packing and/or shipping of the part to the customer.

Processes and methods consistent with the disclosed embodiments may enable supply chain management systems associated with rotable part exchange programs to manage rotable inventory levels by ensuring an adequate supply of rotable or new material is available within the supply chain. By monitoring and controlling the flow of core material associated with a remanufacturing process or system based on a customer demand for rotable parts, inventory management system may ensure that appropriate stock levels are maintained to meet a customer demand. Furthermore, because inventory management system 140 is configured to replenish new and rotable material based on forecasted customer demand, costly overstocking of rotable or new material may be avoided.

According to one embodiment, the presently disclosed rotable replenishment process may be instituted within part of a larger distribution requirements planning (DRP) system. DRP may include an information system that coordinates the logistics of an overall supply chain management system. This system may be configured to plan and schedule delivery of goods in predetermined time periods (e.g., typically weekly or monthly increments that may extend for a minimum duration associated with an item's lead-time plus a predetermined number of future planning periods which may be 12 to 24 months in duration). DRP analyzes a plurality of scheduled and expected inflows and outflows of material period by period to determine an optimal time to place replenishment orders with the suppliers so as to keep inventory levels to a minimum while maintaining a targeted service level.

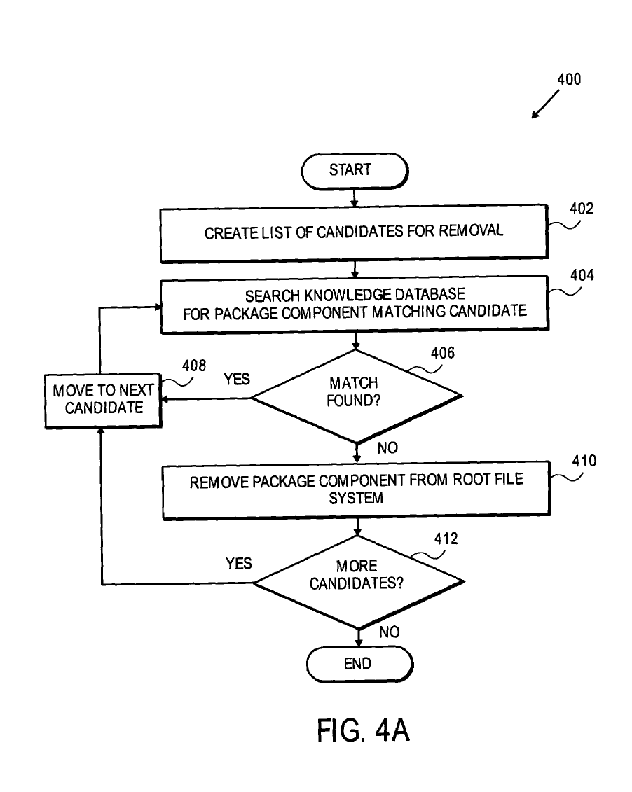

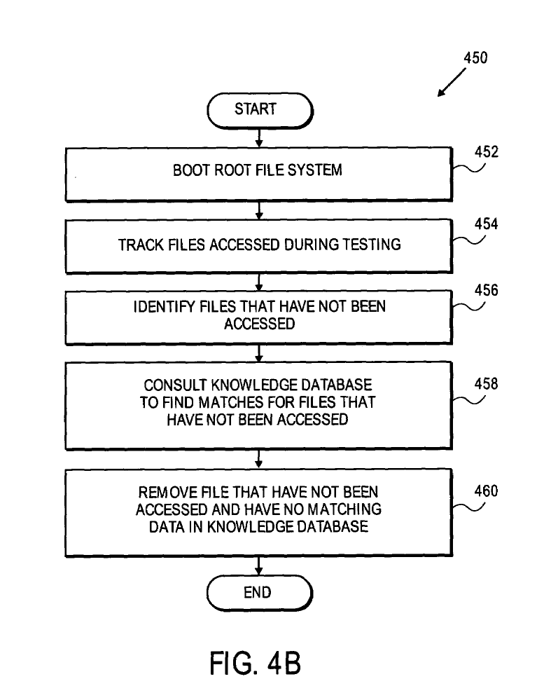

FIGS. 4A and 4B provides a flowchart 900 depicting an exemplary method for replenishing rotable material quantities. As illustrated in FIGS. 4A and 4B, the replenishment process may include a two-part analysis. First, a rotable replenishment process, the process of which is illustrated in FIG. 4A, may determine a projected rotable inventory level for each period associated with a replenishment plan and determine whether an appropriate amount of core material is available to meet the projected rotable requirements. Second, a new material replenishment process (illustrated in FIG. 4B), which may be used for any type of non-rotable part, may determine a projected new inventory level for each period associated with a replenishment plan. Based on the projected inventory, the new material replenishment process may also determine whether an appropriate amount of new material is available to meet the projected new requirements. The new material replenishment process utilizes several data elements associated with an inventory management system as well as data indicative of a rotable deficiency associated with the rotable replenishment analysis. As a result, an output of the rotable replenishment process may be input to the new material replenishment process, thereby allowing new material to be acquired in the event that the available core material is not sufficient to meet the projected rotable demand and/or maintain the rotable inventory above a safety stock level.

As illustrated in FIG. 4A, inventory management system 140 may receive and/or collect rotable replenishment data from a plurality of input streams from an inventory database (Step 910). Replenishment data, as the term is used herein, refers to any data that may be used to project a future rotable part requirement and to determine an amount of rotable and/or new material available to meet the rotable requirement. Replenishment data may include two primary categories: rotable replenishment data and new replenishment data. Rotable replenishment data may include, for example, rotable exchange order data, gross requirement data (event-based data such as a promotion or rotable part recall) for rotable parts, rotable and non-rotable demand data, scheduled receipts of finished/saleable rotable parts from the parts supplier (e.g., remanufactured, overhauled, repaired, etc.), rotable condition data (condition of exchange material from the customer which often determines the repair/remanufacture lead time), and open customer core return data (quantity of core material received). New material replenishment data may include, for example, new part order data, non-rotable demand data, new material inventory levels, gross requirement data for new parts, and scheduled receipts for new materials. It is contemplated that additional, fewer, and/or different types of replenishment data for each of new and rotable parts may be collected, and that the types listed above are exemplary only and not intended to be limiting.

Once the rotable replenishment data has been collected, a next planning period may be examined to determine whether the forecasted rotable requirement can be met based on a future availability of core materials (Step 920). In order to determine whether a forecasted rotable requirement can be met, inventory management system may analyze the received rotable replenishment data to estimate a projected available rotable inventory and a future rotable core quantity associated with the next demand period. Projected rotable requirements may be estimated by determining the scheduled receipt for rotable material that has been sent to a remanufacturer for repair, as well as all other inflows, outflows, and needs for that product.

Inventory management system 140 may determine whether the planning period is the last planning period in a particular planning cycle (Step 930). If the planning period is the last planning period of a rotable replenishment planning cycle, inventory management system 140 may begin preparation for a subsequent planning cycle (Step 930: Yes). If the planning period is not the last planning period associated with the rotable planning cycle (Step 930: No), the projected available inventory may be compared with a safety stock level (Step 940). This safety stock level may include a stock level required to meet a predetermined customer service level. This customer service level may be established by contract between a customer and a parts supplier.

If the projected available rotable inventory exceeds the safety stock level (Step 940: Yes), inventory management system may proceed with planning a subsequent planning cycle. If, however, the projected available rotable inventory is less than the safety stock (Step 940: No), inventory management system 140 may determine whether a quantity of available core materials is sufficient to meet the required rotable inventory needs.

If the quantity of available cores is sufficient to meet the projected available rotable inventory (Step 950: Yes), inventory management system 140 may create a repair order for the required number of rotable parts (Step 952). According to one aspect, inventory management system 140 may automatically prepare a repair order and transmit the repair order to a remanufacturing facility. It is contemplated that, in certain situations, the planning period may exceed a repair lead time for a particular rotable part. In these situations, the repair order may be converted to a forecast repair schedule, which may be provided to the remanufacturing facility. The forecast repair schedule, while not an actual repair order, may aid the remanufacturing facility in planning future repair activities.

If the quantity of cores is not sufficient to meet the projected available rotable inventory (Step 950: No), inventory management system 140 may generate a repair order for the available cores (Step 954). If inventory management system 140 has been configured (e.g., based on a customer request) to allow the order of new material to support a rotable exchange pool (Step 960:Yes), a rotable deficiency for the planning period may be determined (Step 970). Rotable deficiency, as the term is used herein, refers to the quantity of supplemental new condition material required to meet the projected available rotable inventory requirements. As illustrated in FIG. 4A, the rotable deficiency may be used as an input to the new material replenishment system, thereby allowing deficiencies in the rotable replenishment process to be supplemented by the ordering of new material.

Once the rotable replenishment process is complete, inventory management system 140 may perform a new material replenishment process, a flowchart of which is provided in FIG. 4B. As illustrated in FIG. 4B, inventory management system 140 may receive new material replenishment data associated with a particular part number from an inventory management database (Step 980). Additionally, any rotable deficiency data by period associated with the part number may be received as an input to the new material replenishment process.

Once the new material replenishment data and any rotable deficiency data has been received, inventory management system 140 may evaluate a next planning period associated with a planning cycle (Step 990). The evaluation of each planning period may include any process for determining, estimating, and/or predicting an amount of inventory required to meet a customer service level for a future demand period. The evaluation may be based on supplier lead time, scheduled receipts of new part shipments, current inventory levels associated with the part number, estimated customer demand for a particular part number, and new material gross requirement adjustments (e.g., adjustments due to product recalls, promotions, sale events, etc.). Inventory management system 140 may estimate a projected available inventory for new material based on the evaluation. As in the rotable replenishment process, if the planning period is the last planning period in the planning cycle (Step 992: Yes), any further data evaluation will occur in the next execution of DRP.

During each planning period evaluation, inventory management system 140 may determine whether the projected available inventory for new material exceeds a safety stock level (Step 994). If the projected available inventory for new material exceeds the safety stock level (Step 994: Yes), indicating that there is sufficient available inventory to meet the projected demand (including any rotable deficiency quantity), inventory management system 140 may continue evaluating a subsequent demand period.

If the projected available inventory is less than a safety stock level (Step 994: No), inventory management system 140 may generate a new purchase order (Step 996). This purchase order may include an order for any new material required to meet requirements for new material and may be generated automatically for any new materials associated with a part number (including supplemental new materials for the rotable pool replenishment process). This purchase order may be provided to a parts supplier via any type of electronic or manual parts ordering system (Step 998). It is contemplated that, in certain situations, the planning period may exceed a repair lead-time for a particular rotable part. In these situations, the repair order may be converted to a forecast repair schedule, which may be provided to the remanufacturing facility. The forecast repair schedule, while not an actual repair order, may aid the remanufacturing facility in planning future repair activities.

According to one embodiment, future core availability may be determined based on a forecasted number of cores received from existing exchange program customers. The number of cores received from existing customers may be determined by applying a washout rate to the number of outstanding rotable cores expected to be received during a future demand period. Washout rate, as the term is used herein, refers to the percentage of time that an item cannot be expected to return from an exchange transaction or is returned but is beyond economical repair. Causes for washout may include, among other things, unreturned or unexchanged core materials, core materials which are permanently damaged, and core materials for outdated or superseded parts. For example, if an exchange pool contains 100 units of rotable parts for a particular part number of which only 85 are returned by a customer and, of those 85 units, only 75 are in condition to be converted to rotable products for resale/exchange, the washout rate for that particular rotable part is 25% (representing the percentage that cannot be remanufactured). As previously explained, rotable exchange material refers to material provided by a customer in exchange for the rotable part, while core material may embody material that is in an unserviceable state that, after a remanufacturing process, may be sold as a rotable part.

Alternatively and/or additionally, washout rate, WR, may be estimated as:

$$WR \approx \frac{( S + NR )}{( R + NR )}$$

where S is received core material identified as “scrap”, NR is the non-returned core material, and R is the core material received from the customer as part of the exchange program.

In accordance with another embodiment, it is contemplated that both rotable and new materials may be ordered during a normal order period (e.g., an order may be placed to cover one or more replenishment requirements during a particular order period or to cover a particular lead-time period with the expectation that the order be due a lead time from order placement). For example, if safety stock exceeds available rotable material, a purchase order may be placed to initiate repair of available core material and a rotable deficiency may be determined to cover rotable requirements for the current and future planning periods.

Alternatively and/or additionally, based on the characteristics associated with a particular rotable requirement, orders may be placed or scheduled to cover future demand periods (beyond immediate requirements for the current planning period) where the number of periods is variable based on the lead time, item cost, and other factors. By ordering through one or more periods of demand (POD) the rotable replenishment process may adapt (based on the replenishment and item indicative data), thereby ensuring that rotable requirements are met for current and future demand periods (that may be well-beyond a “normal” order period).

It is contemplated that inventory management system 140 may be configured to order during normal order periods (to cover current rotable requirements), to order beyond one or more periods of demand (to cover current and future rotable requirements), or both, depending upon the replenishment data associated with each individual part number. By providing a replenishment system capable of placing orders during (or through) one or more demand periods, inventory management system 140 may ensure that adequate rotable material is available without overstocking the warehouse.

### INDUSTRIAL APPLICABILITY

The disclosed system may be used to manage inventory for any rotable parts exchange program. It should be noted that although rotable parts may include various parts and components of larger machines, equipment, or devices, the disclosed system could be implemented for managing inventory of rotable versions of complete machines, equipment, or devices. Therefore “rotable parts,” as referred to herein shall be understood to encompass both complete machines and components of machines.

In addition, although the disclosed system is discussed in the context of parts exchange programs involving purchase/sale transactions, the disclosed system may also be applicable to machine/tool rental programs. In a rental program, rented equipment may, upon return, need to be serviced and, in some cases, recertified before being rented to another customer. Therefore, a rental program involves taking possession of a tool by the customer, turning it back in to the renter, and servicing/repairing the tool by the renter prior to renting it again. In this sense, rental programs are effectively exchange programs, except that in a purchase/sale program, the customer takes possession of the part and turns in the old part being replaced at the same time, whereas in a rental program, there is a time gap (the rental period) between taking possession of the tool and turning in the tool (which happens to be the same tool). Therefore, a “rotable parts exchange program,” as referred to herein, shall be understood to encompass purchase/sale exchange programs, rental programs, lease programs, and the like.

It will be apparent to those having ordinary skill in the art that various modifications and variations can be made to the disclosed method and system for replenishing rotable inventory without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A method for replenishing rotable material associated with a parts exchange program comprising:
receiving replenishment data associated with a part number;
estimating projected rotable requirements based on the replenishment data;
determining a supplemental quantity of new materials required to meet the projected rotable requirements if the projected rotable requirements exceed an available rotable or core quantity;
estimating future new material requirements based on the replenishment data and the supplemental quantity of new materials required to meet the projected rotable requirements; and
generating a purchase order for new material based on the future new material requirements.

2. The method of claim 1, wherein receiving replenishment data associated with a part number includes collecting replenishment data from an inventory management database.

3. The method of claim 1, further including generating a purchase order for rotable material for authorizing a repair of core material.

4. The method of claim 1, wherein estimating the projected rotable requirements includes predicting the projected rotable requirements based on one or more of historical rotable exchange data, a quantity of open rotable exchange orders, rotable gross requirement adjustments, core material returned from the customer, scheduled rotable receipts, planned receipts, and quantity of rotable material onhand.

5. The method of claim 1, wherein estimating the projected rotable requirements includes determining a repair lead time associated with each of the one or more rotable part requests.

6. The method of claim 1, wherein the available core quantity is estimated by determining a quantity of core parts available in inventory and predicting a quantity of core material to be returned based on washout rate associated with one or more part numbers.

7. The method of claim 6, wherein the washout rate is estimated as a percentage based on a quantity of one or more of un-repaired cores to a total quantity of cores in the exchange program.

8. The method of claim 6, wherein the washout rate, WR, is estimated as:
$$WR \approx \frac{( S + NR )}{( R + NR )}$$
where S is scrap core material, NR is non-returned core material, and R is core material received from the customer as part of the exchange program.

9. The method of claim 1, wherein determining the supplemental quantity of new materials required to meet the projected rotable requirements includes determining a difference between the projected rotable requirements and the available core and rotable quantity.

10. A computer-readable medium for use on a computer system, the computer-readable medium having computer executable instructions for performing the method of claim 1.

11. An inventory replenishment method for rotable parts comprising:
a rotable material replenishment process comprising:
receiving replenishment data associated with a part number;
estimating projected rotable requirements based on the replenishment data;
determining a supplemental quantity of new materials required to meet the projected rotable requirements if the projected rotable requirements exceed an available core and rotable quantity; and
a new material replenishment process comprising:
receiving new material replenishment data associated with a part number;
receiving data indicative of a supplemental quantity of new materials required to meet the projected rotable requirements;
estimating future new material requirements based on the replenishment data and the supplemental quantity of new materials required to meet the projected rotable requirements; and
generating a purchase order for new material based on the future new material requirements.

12. The method of claim 11, wherein receiving replenishment data associated with a part number includes collecting replenishment data from an inventory management database.

13. The method of claim 11, further including generating a purchase order for rotable material for authorizing a repair of core material.

14. The method of claim 11, wherein estimating the projected rotable requirements includes predicting the projected rotable requirements based on one or more of historical rotable exchange data, a quantity of open rotable exchange orders, rotable gross requirement adjustments, core material returned from the customer, scheduled rotable receipts, planned receipts, and quantity of rotable material onhand.

15. The method of claim 11, wherein estimating the projected rotable requirements includes determining a repair lead time associated with each of the one or more rotable part requests.

16. The method of claim 11, wherein the available core quantity is estimated by determining a quantity of core parts available in inventory and predicting a quantity of core material to be returned based on washout rate associated with one or more part numbers.

17. The method of claim 16, wherein the washout rate is estimated as a percentage based on a quantity of one or more of un-repaired cores to a total quantity of cores in the exchange program.

18. The method of claim 16, wherein the washout rate, WR, is estimated as:
$$WR \approx \frac{( S + NR )}{( R + NR )}$$
where S is scrap core material, NR is non-returned core material, and R is core material received from the customer as part of the exchange program.

19. The method of claim 11, wherein determining the supplemental quantity of new materials required to meet the projected rotable requirements includes determining a difference between the projected rotable requirements and the available core and rotable quantity.

20. A computer-readable medium for use on a computer system, the computer-readable medium having computer executable instructions for performing the method of claim 11.
